(19) United States
(12) Patent Application Publication
(10) Pub. No.: US 2004/0156081 A1
(43) Pub. Date: Aug. 12, 2004

(54) Passive hidden imaging

(75) Inventors: Moshe Bril, Beit Shemesh (IL); Israel Grossinger, Rehovot (IL); Eli Benny, Rishon LeZion (IL)

Correspondence Address: G.E. EHRLICH (1995) LTD., c/o ANTHONY CASTORINA, SUITE 207, 2001 JEFFERSON DAVIS HIGHWAY, ARLINGTON, VA, 22202, US

(73) Assignee: Holo-Or Ltd.

(21) Appl. No.: 10/361,623

(22) Filed: Feb. 11, 2003

(51) Int. Cl. G09C 5/00; H04N 1/44; G06K 15/02

(52) U.S. Cl. 358/3.28; 380/55

(57) ABSTRACT

In a secure imaging system for securing documents or encrypting images, an image comprises an array of printed positions formed using a group of inks each having a predetermined spectrum. The positions are selected to form a predetermined image, either real or virtual, when the image is viewed through an optical processor. An image formed using inks having the same colors as experienced by the human eye, but not sharing exactly the same spectra, will fail to form the correct predetermined image.

### FIELD AND BACKGROUND OF THE INVENTION

The present invention relates to passive hidden imaging and, more particularly, but not exclusively to a passive hidden imaging system useful for counterfeit detection.

In the past, counterfeiting was a laborious and complex process requiring extensive artistic skills and technical ability. With the digital revolution forgery has become very much easier. Anyone with access to appropriate software and a good printer can produce convincing counterfeits of a wide range of items and products. Even a color photocopier can produce a good counterfeit of an unprotected item. Indeed it is estimated that 5% to 8% of world trade is lost to counterfeits.

There is thus a widely felt need to secure the authenticity of items and products ranging from banknotes, credit-cards, vouchers, tickets, legal documents and software, to cigarettes, pharmaceuticals, soft drinks, matches and soap. The aim of a successful anti-counterfeiting system is to meet the following not necessarily complementary aims as effectively as possible:

1. Inexpensive to create at high volume,

2. Inexpensive to customize for low volume, including one-off, production,

3. Inexpensive to verify at any volume,

4. Easy to verify, for example by untrained operators,

5. Hard to falsify (counterfeit), and

6. Optionally inexpensive to verify automatically.

There are numerous anti-counterfeiting measures commercially available including watermarks, special papers, inserts into the paper, complicated printing patterns, hard to copy colored inks, holograms, fluorescent ink and others.

The anti-counterfeiting measures given above use features that are readily detectable, and the protection provided relies on the features simply being expensive or complicated to reproduce. Other anti-counterfeiting measures rely on being undetectable. Digital or machine-only readable marks rely on not being noticed by the counterfeiter so that he copies the product whilst unwittingly failing to copy the mark or failing to relate to the mark in some other way whilst copying the product. Often in these cases the mark is vulnerable to the more sophisticated counterfeiter who does detect the mark and is able to relate thereto, generating a counterfeit product giving a false sense of being genuine. A disadvantage of the hard-to find marks is that authentication cannot be carried out without special equipment. Indeed in some cases the security of the system requires that the authentication equipment is not made widely available.

Each of the known methods fulfils some of the above requirements but not others, and therefore none of them provide a universal anti-counterfeiting system suitable for all kinds of products whatever the value.

There is thus a widely recognized need for, and it would be highly advantageous to have, an anti-counterfeiting system devoid of the above limitations. In particular it is desirable to have a system which can be inserted into products, cheaply and easily, which can be verified cheaply and easily with equipment that can be widely distributed, and yet the availability of the equipment should not make the system easier to counterfeit.

### SUMMARY OF THE INVENTION

According to one aspect of the present invention there is provided a printed mark comprising an array of printed positions each formed from one of a group of inks each having a predetermined spectrum, the positions being selected such as to form a predetermined image when the printed positions are viewed through a predetermined optical processor.

Preferably, the image is a virtual image. Additionally or alternatively, the image is a real image.

Preferably, the predetermined image is a spectral domain image.

Preferably, the predetermined printed positions form at least two object structures, and wherein the predetermined image comprises at least one image structure contributed to via the optical processor by the at least two object structures.

Preferably, the image comprises a product identification code.

The mark, as opposed to the image, may itself comprise a product identification code.

The mark may comprise a digital printed pattern, wherein each printed position is a single print pixel.

Preferably, the optical processor comprises a diffraction element.

Preferably, the optical processor comprises a filter element.

Preferably, the optical processor comprises a prism.

In a preferred embodiment, the optical processor is customized per mark.

Preferably, the group of inks is taken from a larger pool of inks.

Preferably, the pool comprises at least two inks having substantially a same color but a different spectral composition.

Preferably, the group of inks comprises at least six inks.

Alternatively, the pool of inks comprises at least 25 inks.

In particular embodiments, the image comprises an identity photograph or is any other kind of information carrying image.

According to a second aspect of the present invention, there is provided a document carrying a mark, the mark comprising an array of printed positions each formed from one of a group of inks each having a predetermined spectrum, the positions being selected such as to form a predetermined image when the printed positions are viewed through an optical processor.

The document may further carry a printed version of the predetermined image for verification.

According to a third aspect of the present invention there is provided packaging, carrying a mark, the mark comprising an array of printed positions each formed from one of a group of inks each having a predetermined spectrum, the positions being selected such as to form a predetermined image when the printed positions are viewed through an optical processor.

Preferably, the packaging carries a printed version of the predetermined image for verification.

According to a fourth aspect of the present invention there is provided electronically readable data storage medium, carrying a printed mark as part of a label or the like, the mark comprising an array of printed positions each formed from one of a group of inks each having a predetermined spectrum, the positions being selected such as to form a predetermined image when the printed positions are viewed through an optical processor.

Preferably, the medium is any one of a group including: a magnetic disk, an encased magnetic disk, an optical disk, an audio tape, an encased audio tape, a video tape, and an encased video tape.

In a preferred embodiment, the mark or the verification image is additionally stored in the medium in electronic form, including a form suitable for transfer by electronic mail.

Additionally or alternatively, the mark or verification image therefor, is stored thereon in encrypted form.

The encrypted mark is decryptable via a verification apparatus for reproducing the image.

According to a fifth aspect of the present invention there is provided a banknote carrying a mark, the mark comprising an array of printed positions each formed from one of a group of inks each having a predetermined spectrum, the positions being selected such as to form a predetermined image when the printed positions are viewed through an optical processor.

In a preferred embodiment, the banknote additionally carries a printed version of the predetermined image for verification.

According to a sixth aspect of the present invention there is provided apparatus for defining a source object comprising an array of printed positions using a group of inks each having a predetermined spectrum, the apparatus comprising:

an image definer for defining an image,

a reverse optical processor, associated with the image definer, for calculating a source image that leads via predetermined optical processing to the image,

and an output, associated with the reverse optical processor for providing at least a definition for printing the source object.

Preferably, the optical processing comprises a polarization dependent effect.

Preferably, the polarization dependent effect comprises retardation.

Additionally or alternatively, the polarization dependent effect comprises optical isolation.

Preferably, the array of printed positions form at least two object structures, and wherein the source object is defined such that the image comprises at least one image structure contributed to, via the optical processing, by the at least two object structures.

Preferably, each printed position is a high precision pixel.

Preferably, the optical processing comprises diffracting.

Additionally or alternatively, the optical processing comprises filtering.

Preferably, the optical processing is customized for given images.

Preferably, the group of inks is taken from a larger pool of inks.

Preferably, the pool comprises at least two inks having substantially a same color but a different spectral composition.

Preferably, the group of inks comprises at least six inks.

Alternatively, the pool of inks comprises at least 25 inks.

According to a sixth aspect of the present invention there is provided image forming apparatus for forming an image from a source object, the source object comprising an array of printed positions each formed from one of a group of inks each having a predetermined spectrum, the positions and the inks having been selected to form a predetermined image with an optical processor, the apparatus comprising such an optical processor, and a source item holder, the source item holder being located to define a predetermined distance between the optical processor and a source object in the source item holder, thereby to form an image to correspond to the predetermined image.

Preferably, the image is a spectral domain image.

Preferably, the array of printed positions form at least two object structures, and wherein the source object is defined such that the image comprises at least one image structure contributed to, via the optical processor, by the at least two object structures.

Preferably, a packaging of an item carrying the object serves as the source item holder and is operative with the optical processor to define the distance.

Preferably, the optical processor is embedded in a packaging of an item carrying the source object.

Preferably, the optical processor is embedded in the packaging.

The apparatus may comprise an illumination source for illuminating the source object. The illumination source may be a white light source or may comprise specific wavelengths or may provide polarized light or conform to other lighting specifications as desired.

Preferably, the apparatus is operable to create the image at the retina of the eye of a verifier.

The apparatus preferably comprises a display screen for displaying a projection of the image.

Preferably, the display screen comprises diffusion angle limitation.

Preferably, the predetermined distance is variable per source object.

Preferably, the optical processor comprises a diffraction element.

Preferably, the optical processor comprises a filter element.

Preferably, the optical processor comprises a prism.

Preferably, the optical processor is exchangeable in accordance with definitions for each source object.

According to a seventh aspect of the present invention there is provided a method of defining a source object for a predetermined image comprising:

carrying out reverse optical processing of the predetermined image,

using the reverse optical processing to select pixel positions for printing the source object, and

using the reverse optical processing to select ones from a group of inks each having a predetermined spectrum, for the selected pixel positions, thereby to define the source object.

Preferably, the carrying out reverse optical processing comprises determining source object parts from image parts, placing into a look up table and then building the source image by compiling the parts from the look up table.

Preferably, for at least some image parts there are a plurality of possible source object parts.

Preferably, one of a group comprising random selection, systematic selection according to a formula and user selection, is used to select between the plurality of possible source object parts.

Preferably the method further comprises printing the source object.

Preferably, the printing is carried out on a document.

Additionally or alternatively, the printing is carried out on packaging.

Additionally or alternatively, the printing is carried out on currency notes.

Preferably, reverse optical processing comprises processing from a spectral domain to a spatial domain.

Preferably, the selected pixel positions form at least two object structures, and wherein the source image is defined such that the image comprises at least one image structure contributed to, via optical processing, by the at least two object structures.

Preferably, the reverse optical processing comprises modeling in reverse an effect of a diffraction element.

Preferably, the diffraction element is a customized diffraction element.

Preferably, the reverse optical processing comprises modeling in reverse an effect of a filtering element.

According to an eighth aspect of the present invention there is provided a method of verifying authenticity of a mark-bearing item, the mark comprising an array of printed positions each formed from one of a group of inks each having a predetermined spectrum, the positions being selected such as to form a predetermined image when the printed positions are viewed through an optical processor, the method comprising:

applying the optical processor to form an image,

comparing the formed image with the predetermined image, and

if the formed image coincides with the predetermined image then authenticating the image bearing item.

In one embodiment, the predetermined image is a spectral domain image.

Preferably, the optical processor comprises a diffraction element.

Preferably, the optical processor comprises a prism.

Preferably, the optical processor comprises a filtering element.

Preferably, the predetermined image is carried on the image-bearing item.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing selected tasks or steps manually, automatically, or a combination thereof. Moreover, according to actual instrumentation and equipment of preferred embodiments of the method and system of the present invention, several selected steps, in particular involving formation of the virtual image, could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a diagram showing a basic printed object image according to a first preferred embodiment of the present invention;

FIG. 2 is a diagram showing a basic virtual image formed from the object image of FIG. 1, according to the first preferred embodiment of the present invention;

FIG. 3 is a simplified spectral diagram showing a comparison between wavelengths used in conventional dies or inks and in two specialized inks of the kind suitable for use in the present embodiments;

FIG. 4 is a simplified diagram showing apparatus for forming a virtual image from a printed object image according to a preferred embodiment of the present invention;

FIG. 5 is a simplified schematic diagram showing the operation of the optical element of FIG. 4 on two regions of a printed block;

FIGS. 6-15 are a series of illustrations showing printed object images and the virtual images formed therefrom and demonstrating how verification fails for a counterfeit image; more specifically, FIG. 6 is a key for the printed object images that follow, FIG. 7 is a key for the virtual images that follow, an original printed object image is shown in FIG. 8, and successful verification thereof is shown in FIG. 9; a forged image is shown in FIG. 10; and FIG. 11 shows how verification of the forged image fails;

FIGS. 12-15 are close up views of FIGS. 8-11 respectively

FIG. 16 is a simplified flow chart illustrating automatic generation of a printed object image according to a preferred embodiment of the present invention;

FIG. 17 is a simplified flow chart illustrating generation of a look-up table for use in the embodiment of FIG. 16;

FIG. 18 is a simplified flow chart illustrating an alternative to the embodiment of FIG. 16 for generating a printed object image; and

FIG. 19 illustrates a modification of the apparatus of FIG. 4 for automatic acquiring of the virtual image for use in automatic verification.

### DESCRIPTION OF THE PREFERRED EMBODIMENTS

The present embodiments provide a printed matter verification system that uses wavelength properties of inks and dies to form a pattern in a virtual domain such as the spectral domain, hereinafter the image, and therefrom to work back, using optical processing, to an apparently random object in an object domain which can be printed on any printing surface. Herein the term “spectral domain” refers to any image domain which is derived from the domain of an original image by means of optical processing that operates differentially on different wavelengths. The object can then be optically processed to reproduce the desired image in the image domain. The object may be copied in a forgery attempt but, even if the colors are reproduced correctly, the image does not appear. In order to reproduce the image successfully it is necessary to use dies or inks having identical wavelength spectra. It is also necessary to use these inks in the same weight on each coordinate of the object pattern as the real object pattern.

The type of optical processing may be varied, as may the inks being used. The object itself may be printed at a highest possible print precision, which precision must also be reproduced correctly in order to reproduce the image.

The present embodiments encompass the printed apparently random image itself, hereafter the printed image or in optical terms the object, as well as apparatus for calculation and/or formation of the object, and apparatus for verification of the object by optical processing to reproduce the image, which may be a virtual or a real image.

The present embodiments are intended for verification of any kind of printed material, and can be useful for examples ranging from banknotes to documents to packaging and also to electronic data carriers such as music or program disks and to any kind of item or product on which it is possible to print or otherwise introduce a precise object form.

The embodiments describe a way to create encrypted marks and to verify the authenticity of these marks. The core of the verification method consists of a wavelength dependent optical component or system. The optical component system provides a kind of encrypted object pattern from which can be provided an easy to verify, and /or predefined, image. The image may be viewed at a screen, detector or at the naked eye of an observer, depending on the verification apparatus used. Very similar or identical looking object marks may, using the methods and apparatus of the present embodiments, produce clearly differing images enabling easy identification by the user of the genuine article vis a vis a forgery.

Beyond the field of verification, the system is useful more generally for encrypting images.

The principles and operation of a printed matter verification system according to the present invention may be better understood with reference to the drawings and accompanying descriptions.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

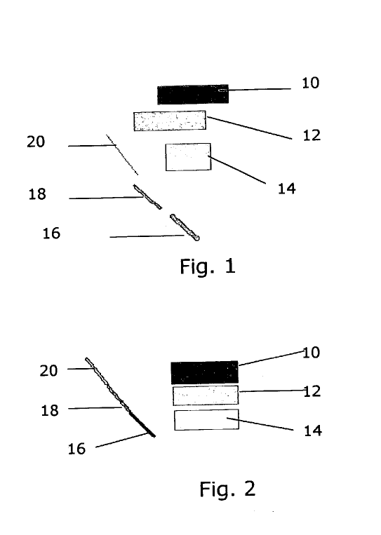

Referring now to the drawings, FIGS. 1 and 2 are simplified schematic diagrams illustrating highly simplified verification objects and images according to a first preferred embodiment of the present invention. FIG. 1 is an example of an apparently random object as printed on the item it is desired to protect. FIG. 2 is the image of FIG. 1 as viewed after optical processing. More specifically, FIG. 1 comprises three non-aligned and unequally sized and proportioned bars of different colors, respectively 10—blue, 12—orange, and 14—red, and also three non-aligned line segments 16—dark green, 18—light green and 20—orange, of different lengths and thicknesses.

FIG. 2 shows an image of FIG. 1 after simple optical processing involving use of a wavelength dependent optical system, that is to say an optical system/assembly or element whose optical function (strongly) depends on the wavelength of the light being therefrom processed by the system/assembly or element. The various elements are given the same reference numerals as their originating elements in FIG. 1. The wavelength dependent optical system bends light by different amounts depending on the wavelength. In the case of FIG. 1, an appropriate wavelength dependent optical system causes the three bars 10-14 to take on substantially identical shapes and to line up with each other. In particular the effect on the orange bar 12 is to be noted. In a standard RGB or CMY printing system, orange is synthesized using a mixture of colors, and under optical processing the orange bar would be analyzed into separate visual entities according to the constituent wavelengths. However, in the present embodiments, an orange die having a single wavelength peak at a predetermined position in the orange part of the spectrum is used for bar 12. Optical processing therefore reproduces bar 12 as a single entity. However, it is not sufficient merely to use a die having a single wavelength peak in the orange part of the spectrum. In order to achieve alignment it is necessary to use a die having a peak at or very close to that used in the original image calculation, and the same applies to each color used in the image.

The lines 16, 18 and 20 of FIG. 1 reappear in FIG. 2 not merely aligned and with equal thickness, but also the orange line 20 has changed color to pink, and the dark green line 16 has changed shade. As will be explained in greater detail below, the result is achieved by working the optical processing in reverse from a desired image, as in FIG. 2, to determine the printed object of FIG. 1. The kind of combined color and shape change achieved in FIG. 2 can be achieved simply using a die having two peaks, each of which behaves differently during the optical processing, or by using mixtures of different dies printed together as separate dots in the same structure. The color changes are achieved by regions of one color from one printed structure coinciding in the image with another color from a different structure and vice versa.

The image of FIG. 1 may be applied to banknotes, packaging, documents, magnetic and optical discs and other data carriers having labeling, and any other printed matter for which verification is required.

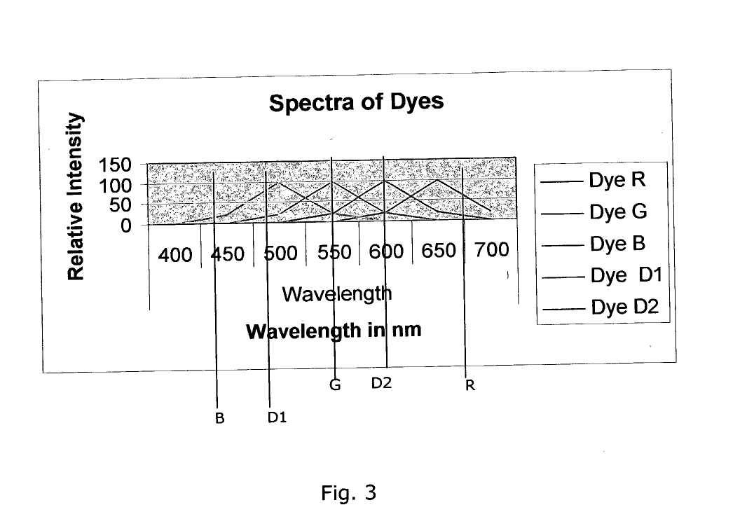

Reference is now made to FIG. 3, which is a conceptual graph showing spectra of standard RGB colors versus those of two special inks or dyes herein labeled D1 and D2. Real data may differ slightly from that of the graph as shown. Any color created using the RGB three color system has a spectrum which is some combination of the three spectra labeled R, G and B, or more precisely using a color coordinate system such as Hunter's L, a and b or C.I.B.'s X, Y and Z. The three colors are capable of being combined to create practically any other color in the spectrum to the satisfaction of the human eye which itself sees color using a three color system. Although exact color matches to the D1 and D2 dies can be created using the RGB system, the spectrum of the match is completely different to that of the two dies and optical processing according to the present embodiments is able to detect that difference, and indeed is sufficiently sensitive to detect even slight differences in wavelength.

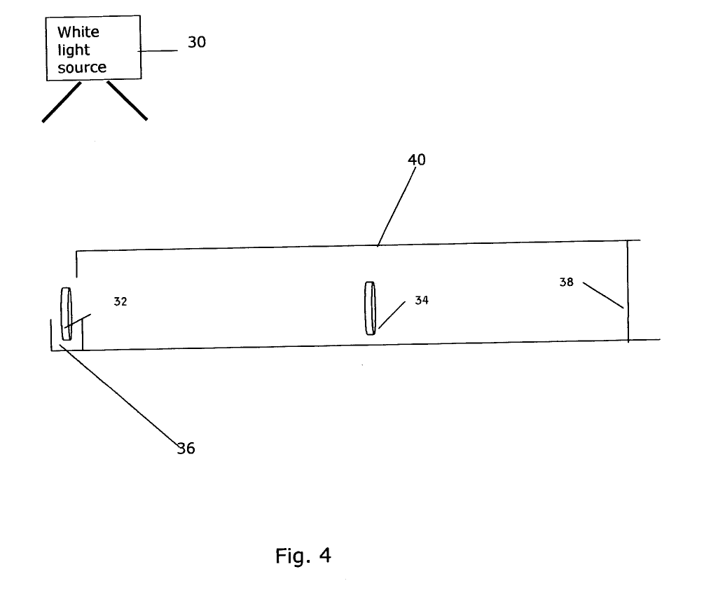

Reference is now made to FIG. 4, which is a simplified diagram showing apparatus for forming and viewing the image, according to a preferred embodiment of the present invention. A white or other broad waveband light source or ambient light, 30 illuminates an item 32 on which is printed an object of the kind shown in FIG. 1. The item 32 is aligned with an optical element or system 34, which may be a diffractive optical or like element, preferably combined with one or more lenses. As will be explained below, a lens is useful to provide a parallel beam at the diffraction element. In order to ensure maintenance of a specified distance between the item 32 and the optical element 34, the item is preferably mounted in an item holder 36, which is maintained at the specified distance.

A screen 38 is located on the far side of the optical element for projection thereon of the image. The holder 36, the optical element 34 and the screen 38 are preferably located within a housing 40. The housing 40 may optionally be sealed so as to render it difficult to inspect the optical element or the distance between the holder and the optical element. For example the housing may be designed to move or distort the optical element if an attempt is made to open it. In a particularly preferred embodiment the optical element comprises a slightly elastic or resilient material, which is held at a desired shape by the housing. As soon as the housing is broken, the optical element returns to its original shape, thus rendering it difficult to analyze its optical properties.

In use a person wishing to verify the authenticity of an item simply places the item in holder 36. The item is illuminated by illumination source 30 and the optical element 34 forms a real image, in other embodiments it could be a virtual image, which can be viewed on screen 38. If the image viewed on the screen corresponds to the intended image then the item is authenticated.

In an alternative embodiment, instead of a white light source, a light source of any predefined characteristics, such as spectral intensity, polarization characteristics, and uniformity in one respect or another or any other lighting specification could be utilized. Only verification using the correct light source produces the correct image.

Likewise it is possible to specify a particular ambient lighting environment.

The system as described above is preferably used with a set of unique inks. In a preferred embodiment the system is used with a group of around 25 inks. Any particular pattern uses only a subset of the inks, typically between three inks for low security and six inks for high security applications. It is further envisaged that any given printing house would not be given access to all of the inks. Now some of the inks in the group preferably share the same colors, although having different spectral profiles. Preferably, in a preferred system for using the present embodiments, any given printing agent is given only one ink of each given color. As the printed object patterns can use mixtures of inks representing several colors on the same object in different ways, a printing house that has the correct inks and a correct printed pattern still will not easily know where to print what ink. It will be appreciated that the inks in the group that share the same colors, will have different spectral profiles, since they are made up from different dies. The colors being the same render an analysis more difficult. Even if the printing agent manages to determine the amount of special ink used in each coordinate and can reproduce other object patterns correctly with the special colors it has been given, the differences should still show up at verification. Thus, with appropriate management of the system, even an authorized printing agent is in general only able to print the patterns it has been authorized to print and is unable to forge other patterns. The term printing agent is used herein to include any organization that prints, including any print house, packaging makers who carry out their own printing, and any organization which organizes or carries out printing.

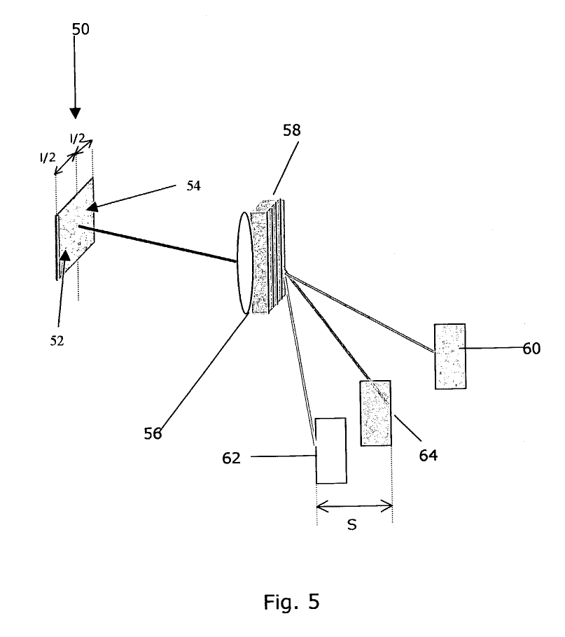

Reference is now made to FIG. 5, which is a simplified schematic diagram showing the operation of an optical element on two regions of a printed block. A printed block 50 is printed in a certain orange hue. A first region 52 is formed using a three color system in which red and yellow pixels combine as necessary to form the required shade of orange. A second region 54 is printed using an orange ink of exactly the same hue but having a single spectral peak in the orange region. In an experiment the object 50 comprised an orange macro-pixel of size 0.4×0.2 mm in which the left part consisted of a mixture of red and yellow dots and the right part consisted of pure orange dots having a strong spectral peak at 575 nm.

The optical system in FIG. 5 is an imaging spectrograph and comprises a grating 56 and a lens 58. Improved embodiments, that is to say for improved resolution, may include two lenses of equal power, one to create a parallel beam at the input of the grating, just before the grating, and one to create an image at the focal point after the grating. In the simplified set up of FIG. 5 the function of these two lenses is replaced by a single lens with twice the power, which may be placed just before or just after the grating.

The results produced in the virtual or real image comprised three structures, structure 60 formed by diffraction of the red pixels through the grating, structure 62 formed by diffraction of the yellow pixels and structure 64 formed by diffraction of the orange pixels.

Considering the experiment mathematically:

In the Object Plane:

Firstly we take three-dimensional Cartesian co-ordinates: Xo, Yo, Zo.

The dimension of the macropixel 50 is 0.4 mm×0.2 mm, giving a width for the part or single pixel ΔX=0.2 mm.

It is noted at this point that the magnification and location of the focal distance of the lens does not change significantly within the wavelength region under investigation. The system is described in the following using the paraxial approximation.

Refractive Lens Theory:

Imaging rules with thin lens approximation gives:

$$\frac{1}{f} = \frac{1}{S} + \frac{1}{{S}^{′}}$$

where

$${S}^{′} = {( \frac{1}{f} - \frac{1}{S} )}^{- 1}$$

and

$$M = \frac{{S}^{′}}{S}$$

also:

f=The focal length of the lens ignoring the dependency on wavelengths.

S=The absolute distance between the object plane and the lens.

S′=The absolute distance between the image plane and the lens

M=The magnification of the lens.

Blazed-Grating Theory:

The grating diffracts rays according to the rule:

$${X}^{′} = {S}^{′} \cdot \frac{λ}{d}$$

Where:

d=the period of the blazed grating,

λ=the wavelength of the ray, and

X′=the coordinate of the image along the x-axis on the image plane.

At the Image Plane

The width of the image along the x-axis is ΔX′=M·ΔX.

With λ_{Y}=0.525 μm (Yellow), λ_{R}=0.625 μm (Red), λ_{O}=0.575 μm (Orange), and the macro-pixel, as mentioned above, having been set to 0.4*0.2 mm, i.e. a real pixel is 0.2*0.2 mm.

The magnitudes of the various parameters were set in the experiment as follows:

| | |
|---|---|
| d | 20 μm |
| S | 80 mm |
| f | 20 mm |

Diameter of the lens: 8 mm

F=20 mm

S′=40 mm

S=40 mm

M=1

d=20 um

The nominal displacement of the orange pixel is 2.1 mm

The Magnification is 1

Under the above conditions a virtual image was obtained having the following parameters:

The width of each Sub-pixel in the image=WSP=0.2 mm

The relative displacement of the orange pixel relative to the red pixel=0.2 mm

The relative displacement of the yellow pixel relative to the orange pixel=0.2 mm

The relative displacement of the orange pixel relative to the red pixel=0.2 mm

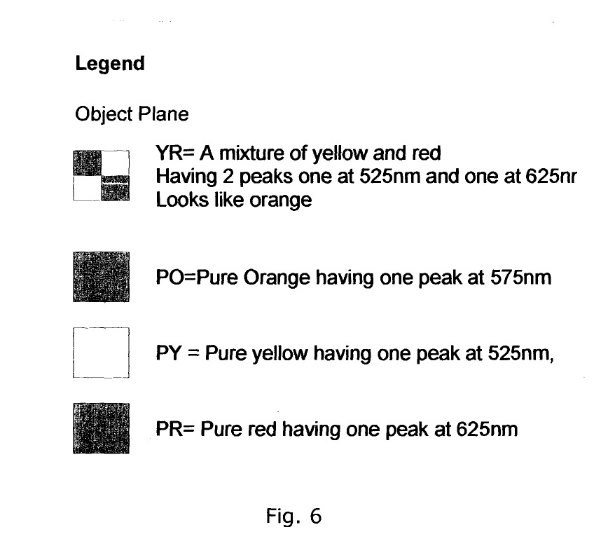

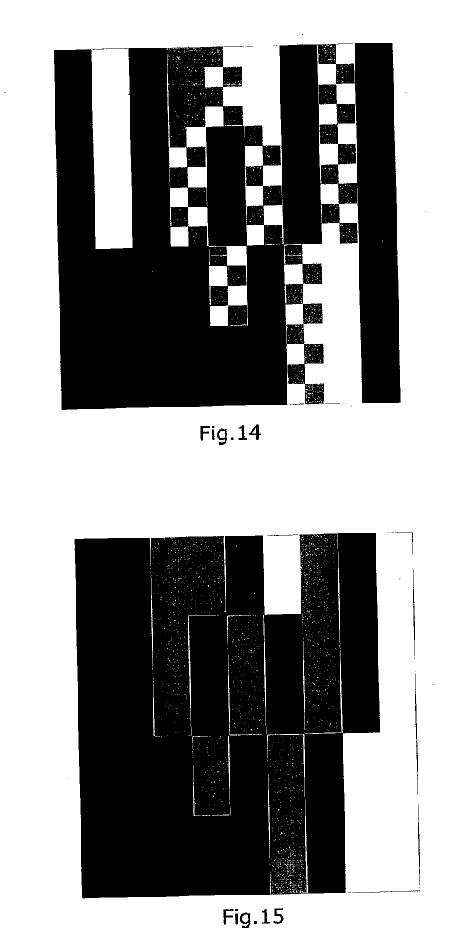

Reference is now made to FIG. 6-15, which are a series of figures illustrating an original printed object and resultant images following optical processing. The objects are of a higher level of complexity than that shown in FIG. 1. The series shows successful verification of the object as well as unsuccessful verification of a forged object.

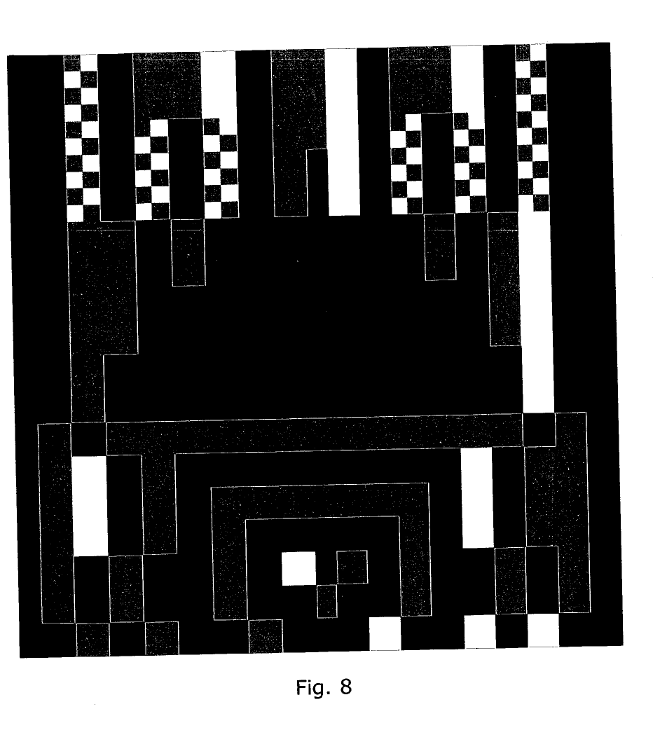

More particularly, FIG. 6 is the legend for the printed objects, showing a first region YR being a mixture of yellow and red dots, or dots with an ink having a strong yellow and red peak. The mixture has two spectral peaks, one at 525 nm and one at 625 nm. The mixture looks to the human eye like orange. A second region, denoted PO, is pure orange, having a single spectral peak at 575 nm. A third region is denoted PY, pure yellow, and has a single spectral peak at 525 nm. A fourth region is denoted PR, pure red, and has a single spectral peak at 625 nm. FIG. 6 provides the legend for FIGS. 8, 10, 12 and 14.

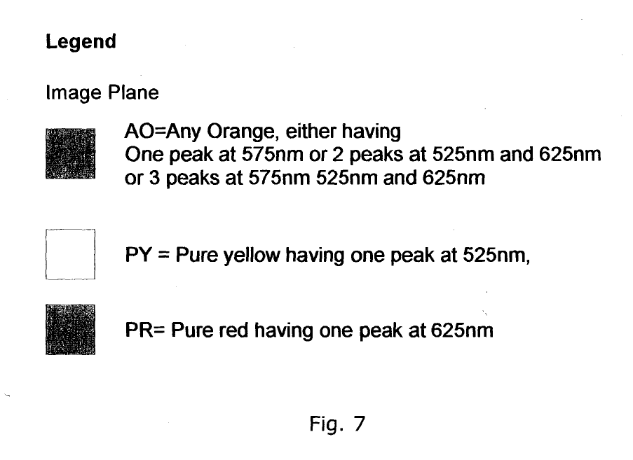

Reference is now made to FIG. 7, which provides the legend for the verification images. A different legend is used because as far as the image is concerned we are only interested in perception by the human eye. It is not meaningful in the image to distinguish between the pure orange and the yellow red mixture since both are perceived by the eye carrying out verification as the same. Thus the region marked AO indicates any orange, either that having a single peak or the mixture having two peaks. The other regions are the same as in FIG. 6.

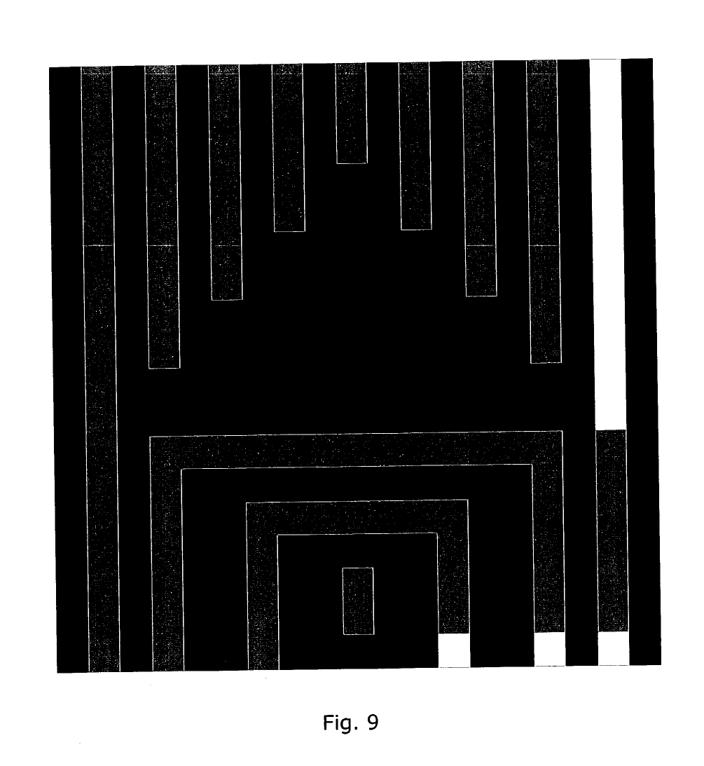

FIG. 8 shows a complex image that makes use of three colors, red, orange, and yellow, to form red regions, yellow regions and orange regions. The orange regions comprise pure orange regions and mixed yellow-red regions that appear identical to the pure orange regions to the naked eye but in fact are not. FIG. 9 shows the image of FIG. 8 following optical processing with the device of FIG. 4. A recognizable pattern is produced which can be compared with a previously distributed sample pattern or may be made available in other ways.

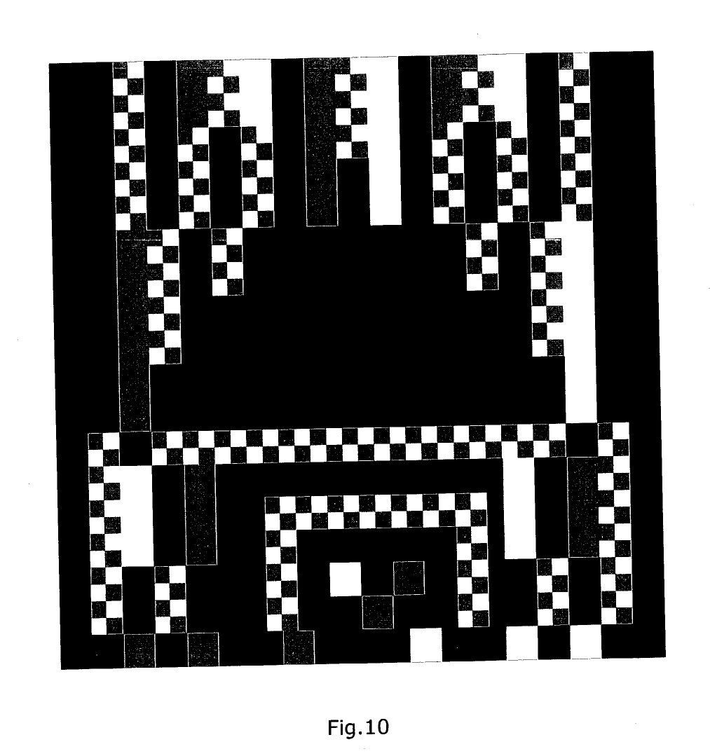

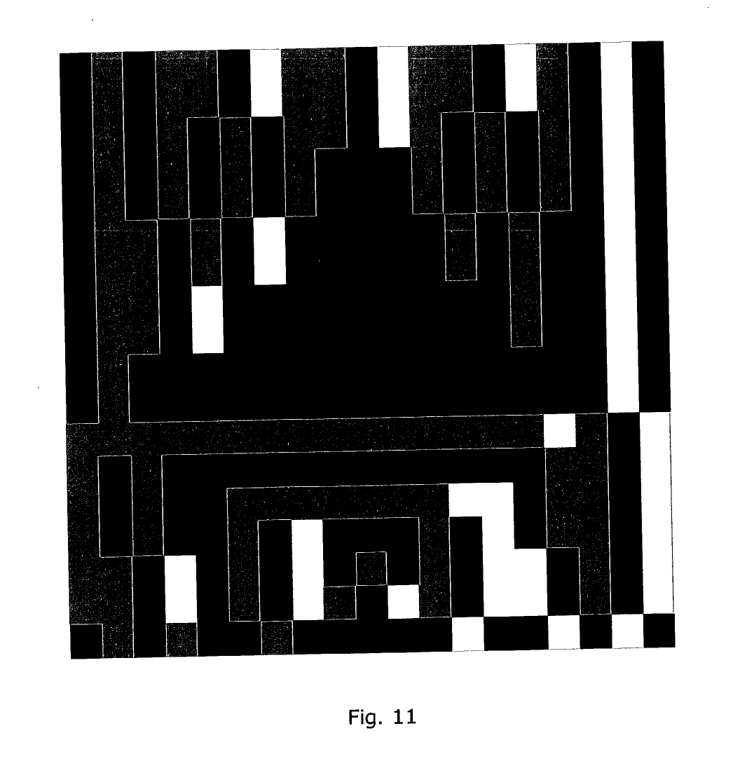

FIG. 10 shows a printed object which looks identical to the human eye to that of FIG. 8. However the object is made up entirely of red and yellow pixels and does not contain any true orange. When put through the same verification process the pattern of FIG. 11 is produced, which is markedly different from that of FIG. 10, even though the human eye is unable to distinguish between true orange and an orange constructed from mixing of red and yellow.

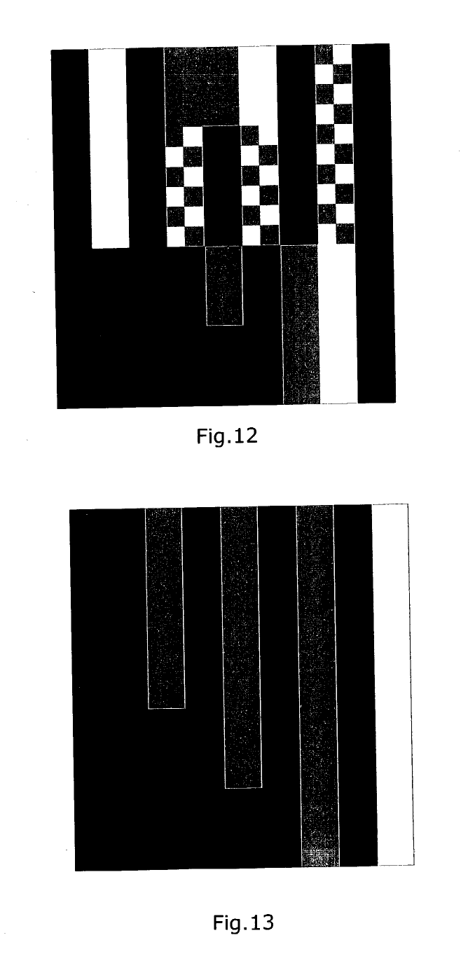

FIGS. 12 to 15 are close-ups of respective parts of FIGS. 8-12 illustrating the same points in greater detail.

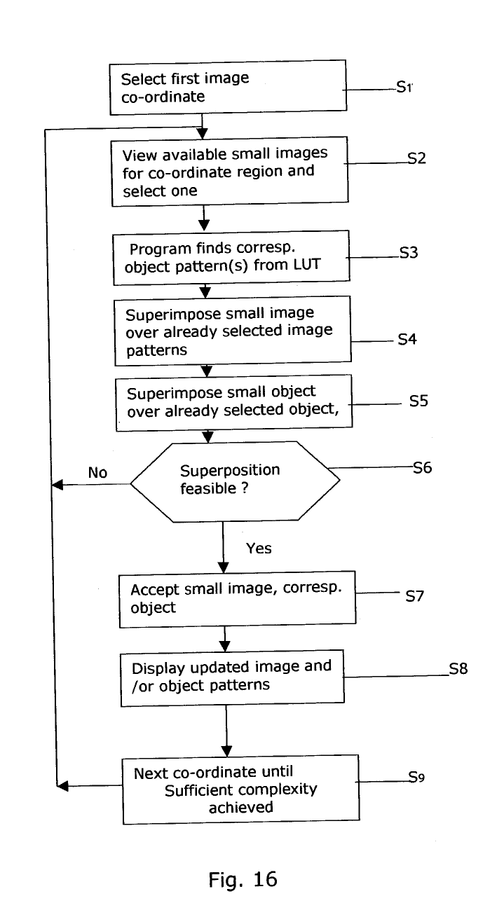

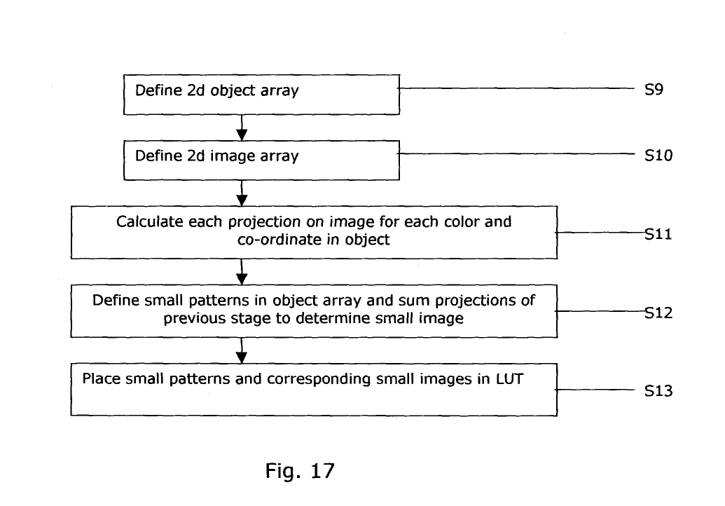

Reference is now made to FIG. 16, which is a simplified flow chart showing a procedure for generating an object from an image, according to a preferred embodiment of the present invention. The procedure makes use of a look-up table relating object domain pixels to image domain pixels and FIG. 17 below describes a procedure for generation of the look-up table. In FIG. 16 a first stage S1 comprises selecting an image co-ordinate. In a succeeding stage S2, the user is shown image micro-pattern possibilities available for selection in the region of the selected co-ordinate. The user selects one of the possibilities. The micro-patterns shown to the user at stage S2 are small and basic patterns which the intention is to combine into a final object and image of a required level of complexity.

In a stage S3, the program consults the look-up table and finds the object micro-pattern that leads to the user selected image micro-pattern. Instead of a look-up table a further preferred embodiment could in fact calculate the corresponding object micro-pattern using reverse ray drawing.

In a stage S4, the currently obtained image micro-pattern is superimposed over any image micro-patterns already selected to form the overall image pattern, unless of course this is the first co-ordinate, in which case there are no micro-patterns already selected. In stage S5 a corresponding superposition of object micro-patterns is carried out. In a stage S6 a check is carried out to determine that the superposition is in fact feasible. For example for the superposition to work a light level or ink fill level may be required at a certain object co-ordinate that is not in fact feasible in a printed surface, or may be occupied already to create other parts of the image.

If the superposition is found not to be feasible then the flow returns to stage S2 and the user selects another small pattern. If the superposition is feasible then the pattern is accepted and incorporated in a stage S7. In a stage S8 the object or the image or both can be viewed by the user. The user may then select a new co-ordinate, in stage S9, and add a new micro-pattern in the same way. Slowly a larger pattern is built up and the user preferably continues until he has achieved a level of complexity appropriate for the item being protected.

Reference is now made to FIG. 17, which is a simplified flow chart showing the development of the lookup table. In a first stage S9 a two-dimensional object array is defined. In a stage S10, a two-dimensional image array is defined. Then, in a stage S11, each image array position is tested for each color to find out which object positions will light up that image position. Alternatively, each object position is illuminated with each color and the image positions illuminated as a result are recorded. In the latter case, the physical system may be used and in both cases computer simulation based on ray tracing can be used. In a stage S12, illuminated pixels of neighboring positions are superimposed to form the micro-patterns referred to above. The image micro-patterns and the corresponding object micro-patterns are then stored to form the look-up table in a stage S13.

Each coordinate in the image plane corresponds with a field in the LUT. The LUT field may include the following information:

a list of micro-patterns in the image field that includes the coordinate, preferably organized by size (1×1, 1×2, 2×2, etc);

the micro-pattern in the object plane that corresponds with the micro-pattern in the image plane; and

the colors in the image plane, the colors preferably represented by color coordinates such as CIE XYZ.

Furthermore, the colors in the object plane are best represented by codes indicating the ink used, and a specific CIE XYZ Color coordinate image pattern may have several corresponding ink/Object patterns. That is to say, once the user has selected an image pattern, it is not true to say that he has necessarily fully defined an object pattern. To a certain extent, the system of the present embodiments can take on so-called “many-to-one” functionality.

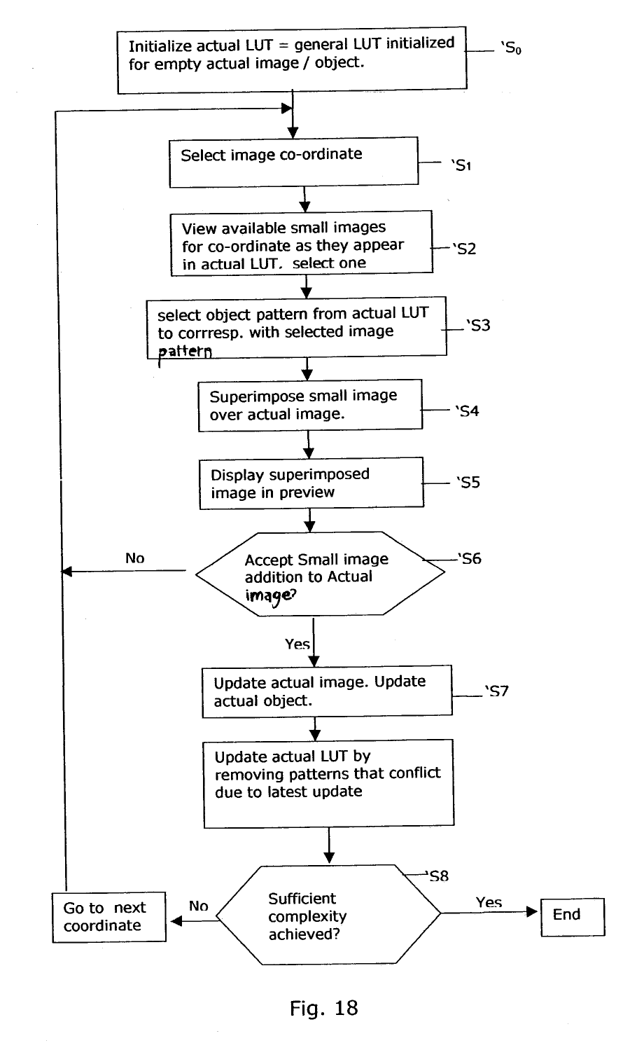

Reference is now made to FIG. 18, which is a simplified flow diagram showing a variation of the embodiment of FIG. 16. The stages are broadly the same as in FIG. 16, and are thus given the same reference numerals with a quotation mark. The following description concentrates on the differences over FIG. 16, and the similarities are not described again except to the extent necessary for an understanding of the present figure.

A first stage 'S0 is provided of initializing a LUT. A generalized LUT is initialized for an empty image. Initialization is necessary because, during the course of the flow the LUT is modified to avoid impossible conditions, as will be explained below. Stages 'S1 and 'S2 proceed as before. In stage 'S3 image micro-patterns as presented to the user are defined using a color coordinate system such as Hunter's L, a and b, or C.I.E's X, Y and Z., that is to say as based on the way it is viewed by the human eye. Thus, it is possible to have several object micro-patterns which are able to give the same image micro-pattern, as explained above in connection with construction of the LUT. Thus in 'S3, whenever a choice of object patterns is met, the program chooses one of the object patterns at random. Alternatively the program may choose in a predefined, that is to say non-random way, or as a further alternative the choice may be left to the user. It is noted that stage 'S3 may be applied directly to the embodiment of FIG. 16, and stage S3 of FIG. 16 may be used in the present embodiment.

In 'S4, the selected small image is superimposed over the existing image, and then the result is displayed to the user in a preview in stage 'S5. In stage 'S6, the user then either accepts or rejects the superposition. If rejected, the process is repeated for the same co-ordinate. If accepted then the flow moves on to stage 'S7. In stage 'S7, the image is updated with the superposition and the object pattern is also incorporated. In addition, the LUT is updated to exclude any object pattern combinations now rendered impossible. That is to say, if a certain object position is now colored in one way, the LUT update excludes all patterns for future co-ordinates that would require that object position to be colored in another way or left blank. In another embodiment, the LUT update allows for additional coloring of the same object coordinate as long as this does not hinder the ability to create the already defined part of the image. Stage 'S7 thus serves as an alternative to the pattern feasibility testing of stage S6 in FIG. 16. Finally stage 'S8 is the same as before.

In selecting between the embodiments of FIG. 16 and FIG. 18, it is noted that restricting the LUT to exclude patterns that contradict the entered patterns is regarded as easier to compute than calculating the feasibility of a given combination. Furthermore the use of combinations gives rise to practical limitations. In particular, in printed surfaces it can be difficult to guarantee an illumination level for verification, and furthermore it is even more difficult to guarantee relative illumination levels between the different colors since, in one preferred embodiment the spectrum of the illumination source is not known, or not exactly known in advance.

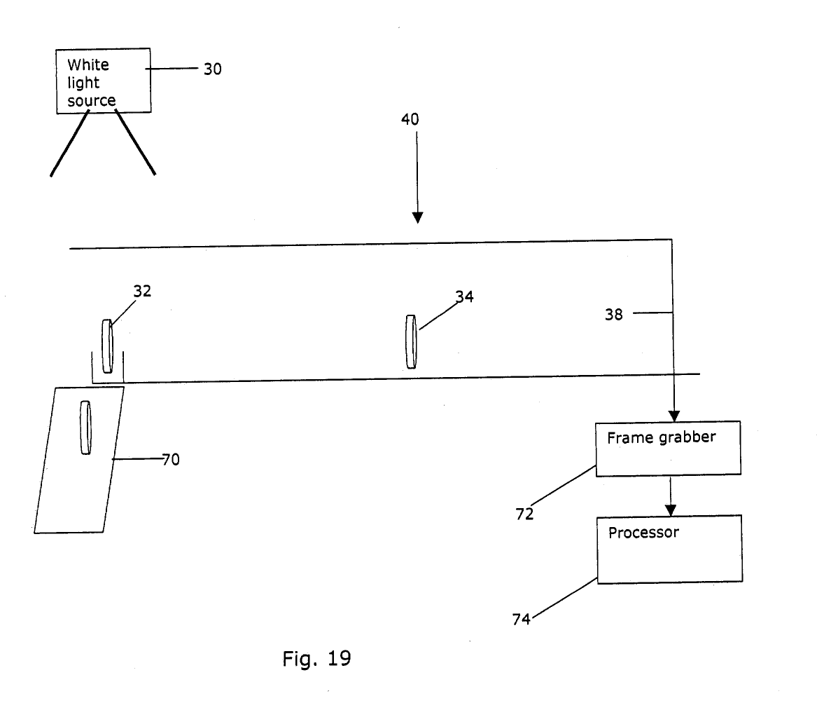

Reference is now made to FIG. 19, which is a simplified diagram illustrating a further embodiment of the present invention intended for automatic and sequential inspection of large numbers of items. A device according to the embodiment of FIG. 18 may for example be installed in a bank for inspecting banknotes. The device is a modification of the embodiment of FIG. 4, and parts that are the same as in FIG. 4 are given the same reference numerals and are not described again except to the extent necessary for an understanding of the present embodiment. A conveyor belt 70, or alternatively a pick and place tool or the like, that is to say any commercially available tool for moving objects from one location to another, places the object to be inspected in the object plane of the verification tool, that is to say in the object holder 32.

As in the basic manual verification tool of FIG. 4, an image pattern is generated, which can be viewed from screen 38. In the embodiment of FIG. 18, a CCD or other detector replaces a simple viewing screen. A frame-grabber 72 then digitizes the image detected by the CCD and feeds it to an image-processing device 74, which may be a PC or micro-controller or any other suitable device having image processing capability.

As an alternative to the use of a screen-based detector 38 and frame grabber 72 one can use a digital camera, or any other commercial detector that is able to digitize images.

The image processor 74 preferably uses pattern recognition software to compare the detected image with the expected image. Preferably the comparison is carried out to a certain predefined accuracy. When the difference between the detected image and the predefined image is found to be within the set accuracy the item is classified as genuine and if not it is classified as false. After the verification or falsification of the item, the automatic verification tool can optionally place genuine objects in one location and counterfeit objects in another location. Optionally, critical determinations may be submitted for review by a human controller. Thus, the device may be set to submit counterfeit determinations, or any determination that is borderline, for review, as desired.

In a variation that is particularly suitable for the automatic embodiment of FIG. 18, the image is a barcode. The system of the present embodiments thus becomes a method and apparatus for encrypting and decrypting barcodes. The image processing needed to read the barcode is simpler than the image processing needed to compare two more conventional and less well-defined images. For reading it is sufficient to use an off-the shelf passive bar-code reader using either a line-ccd, a c-mos imager, a CCD a photodiode or other detector. The bands forming the barcode can optionally move during verification passing different parts of the pattern over the detector, and passive bar-code reading techniques can be used to identify moving parts. The correct bar code gives a number, which can be verified. The identification of the bar-code is therefore the verification of the pattern and the item.

In use an item can be given a standard plain text printed barcode and an encrypted barcode. The genuine item has a certain relationship between the plaintext and encrypted barcodes, which can be tested automatically by the verification apparatus. It is pointed out that barcodes are easy to encrypt using the system of the present embodiments since they are very width sensitive, and optical processing is able to distort line widths easily into a form that is completely scrambled and unreadable.

In a further variation of the embodiment of FIG. 18, image recognition is enhanced in that the comparison between the images is carried out in the frequency domain. The spectrum that is obtained as the image is transformed using a Fourier transform or the like. The Fourier transform tends to have lines of given thicknesses at certain distances apart and it is thus easier to carry out automatic comparisons on Fourier transforms than it is on the images themselves, although the human eye would find it easier to compare the images.

In a yet further variation it is possible to use a spectrometer to take measurements of a region of interest on the image. The spectrum may then be compared with an expected spectrum using a computer or micro-controller or the like.

In a further variation of the embodiment of FIG. 18, the screen 38 comprises a part or all of the correct image pattern, or a negative thereof printed on a transparent substrate. In use, if the image being verified is the correct image, it should fall exactly on the corresponding part of the pattern on the screen and the light will be exactly blocked by the pattern on the screen- or transmitted in the case of the negative. The detector is placed immediately after the pattern and compares the amount of light received when using the pattern against that received with say a reference pattern that does not equal the image. Alternatively the comparison can be with another part of the image. In either case the correct image may be expected to give a certain ratio, which incorrect images are very unlikely to be repeated. The ratio detected may be compared with a predetermined accuracy threshold and provides a measure that verifies the pattern. Threshold verification is preferably carried out electronically and an advantage over the pure image comparison is that it requires fewer computing resources.

In a further variation, the transparent substrate on the screen 38 is replaced by a non-transparent substrate, specifically a reflective substrate. Light from the correct image strikes the reflective substrate and is reflected towards a detector. A focusing lens may be added to focus the reflected light onto the detector. Again, ratios between different parts of the image or between the image and a reference image can be used to measure the similarity and provide an automatic decision.

In a preferred embodiment, one of the definitions provided for forming the image is the distance between the object and the optical element. It is possible to provide a general-purpose verification device having an inactive depth followed by a variable depth. The optical element can be moved over the variable depth region in accordance with a definition provided alongside the verification image. In a further variation, the depth that is set is a non-linear function of a slider. That is to say the verification device is provided with a slider having marked points and the definition tells which of the marked points to use in setting the slider. However the actual positioning of the optical element is randomly or otherwise non-linearly determined and is not proportional to the position of the slider.

Instead of using a screen it is possible simply to use an eyepiece or simply to allow a user to position his eye behind the optical element. Not using a screen allows the system to work at lower light levels, and may thus reduce the need for a built in illumination source. That is to say, ambient light may be sufficient, which may be the case for a set-up with a screen as well in certain configurations.

As mentioned above, it is possible to print, not just the object, but also the expected image on the item itself. It is thus possible to save having to distribute the image separately.

As a further variation it is possible to put either the object or the image in a protected logo that can be inserted in a file. The protected logo may store in coded form the data to print out the object or expected image, although of course in printing out the object it is required that the printer is loaded with the appropriate inks. In the case of printing out the image the system provides an extra layer of security in making it difficult for the forger even to find the intended image he must be able to reproduce. However this has the disadvantage of making verification more difficult for the legitimate user since he too cannot easily obtain the intended image with which to compare the result of his verification.

As a further variation of the screen based verification device, it is possible to provide a sliding depth for the screen. Either the screen or the optical element may slide and the distance between would be defined for each given image and provided as part of the verification information. Again there would be an inactive depth and an active depth, the active depth being the part of the depth along which sliding takes place.

In the case of packaged items such as video or music disks, the printed object can be placed on the item surface, and the object may be supplied in transparent packaging. In such a case the packaging itself may be used to define the viewing distance. That is to say the verifying device is of a given size and is designed to be positioned on the packaging. The packaging thickness thus defines the required object distance.

In a further embodiment it is possible to create the required optical function in the transparent packaging itself. Such a system can be of use in tracking illicit repackaging.

It is possible to include an ID or logo or the like either in the printed object or in the image.

It is further possible to use the automatic verification tool as a lock and the encoded image as a key in access control applications. Thus for example the verification tool may include image processing functionality for determining whether the image detected actually matches the expected image. Only if the tool is satisfied that a match has been achieved will it allow access. Thus users who need access say to a research laboratory are provided with credit card-like keys having printed object patterns thereon. The verification tool reads the printed patterns and only if it is satisfied is the bearer given access.

In order to make it more difficult to break into the system it is possible to design a distortion or other add-in function. As long as the function is taken into account at the image formation stage of FIGS. 16 and 17 it makes image formation no more difficult but at the same time makes counterfeiting that much harder.

The system of the present embodiments is preferably used with inks that contain special, and not generally commercially available, pigments. There is a wide choice of such pigments and they are not hard to find and make into inks. It is also not hard for counterfeiters to get hold of such pigments and likewise to make them into inks. What is difficult however is for the counterfeiter to determine which pigments or combinations of pigments the system is actually using and in what quantities, in other words how the inks are made up. That is to say, it is difficult to find out which inks are used on the object pattern, where, and in what weight or intensity,. A successful counterfeiting attempt has to achieve a substantially exact wavelength match for each of the inks used in a given object. The legitimate user however, is able to change his inks as necessary, cheaply and easily, particularly if he notices that a given ink has been compromised, thus leaving the counterfeiter back at his starting position.

Likewise the system may make use of inks that have combinations of pigments that are not used in the industry.

As mentioned above, for additional complexity, it is possible for the system to be designed with a range of inks, several of which are the same color but simply have a different wavelength composition.

Again, for additional complexity, it is possible to create a composite pixel of a specific color, by printing dots of other system colors, in a combination and intensity that is not used in the industry.

Again for additional complexity, it is possible to add a color filter having a given filter function to the optical function. The filter function reorganizes the object pattern by selecting part of the optical spectrum to enhance its impact.

It is possible to include in the verification tool various optical functions to add security to the device. In particular it is useful to add optical functions that are hard to detect or are hard to reproduce by analysis.

Using all of the above variations and others it is possible to provide standard or general-purpose verification tools for the low end low value market and dedicated verification tools for high-end customers such as bank-note printers. The dedicated devices, once designed, can still be cheap enough to be mass-produced to be distributed freely, or at a low price, thereby enhancing security further.

It is further possible to create a digital pattern and then provide it to the print house as a software module. Optionally, the software module includes usage management that only allows the pattern to be printed a limited number of times or only following entry of a password or the like. Thus use of the pattern can be controlled, either for security or for charging purposes.

One embodiment of the present invention limits the diffusing angle of the screen by using a holographic or diffractive diffuser on the screen. Such a reduction in the diffusing angle serves to reduce the loss of light by diffusing the image from the screen over a smaller angle than with conventional diffusing methods. The less light that is lost the clearer the image.

The visibility of the final image may be increased by covering parts of the optical path, especially the region between the screen and the observer.

The complexity of the system may further be increased by creating multiple images from the same object pattern. This may be achieved by having several object patterns that superimpose, or by having several optical elements operating on the same object pattern in parallel, or by creating several orders of diffraction using the same element. Optionally the separate optical elements superimpose their images and can create a predetermined overall pattern.

To summarize, the preferred embodiments are based on making use of an optical element or system that acts very specifically on each one of several narrow wavelength ranges, so that even relatively small wavelength deviations can be seen clearly. That is to say the system provides an infrastructure on which patterns can be selected in which slight deviations in wavelengths will show up very clearly as failures to align and the like. Slight deviations in the wavelength spectrum representing the same color are very hard, or even impossible, for the human eye to spot but geometrical discontinuities are much easier to note.

Light from the sun, a tungsten lamp or any other broadband or white light source that contains large parts of the visible spectrum, or even a more narrow band source but with at least 2 wavelengths, falls on the region of interest, that is to say the region on which the object pattern is printed. The optical function of the optical element preferably creates a well-defined image at the screen, a detector or at the naked eye of an observer.

The marks are in fact encryptions of images and can be generated using the procedure of FIGS. 16 and 17. The encryptions consist of a 0, 1, 2 or 3 dimensional pattern printed with one or more inks, each ink having well defined and specific wavelength information.

The encryptions generate a specific easy to identify image that can be detected directly by the naked eye, via a screen or by another detector.

A standard RGB copier can produce a pattern that appears to the naked eye exactly like the original pattern. This is because the color coordinates, such as the C.I.E.'s X, Y, and Z are the same. The way a standard RGB copier works is to assign a color coordinate from the 3 (or more) basic colors and then print using proportions of the basic colors in accordance with the co-ordinates. The naked eye works in essentially the same way and is thus unable to differentiate easily between the original printed object and a copied or counterfeit printed object produced using standard image reproduction techniques.

However, optical processing according to the present embodiments allows for easy differentiation between images produced from a counterfeit and that from a genuine image.

As an illustration one may consider red, yellow and orange ink, which are each treated differently by the optical element or system. A square, line or dot printed by yellow and red inks together or by a genuine orange ink, looks the same to the naked eye and standard RGB CCD detectors, but very different following processing by a diffraction grating or the like.

The designer of the anti-counterfeiting solution has the freedom to design special optical functions. He is not restricted to a simple diffraction grating but can add any level of complexity that he chooses, and optionally not using a diffractive element at all but only one or more refractive optical elements of any kind. Likewise he may design the verification equipment to make examination of the optical processing difficult. Additionally the designer is free to select and use a variety of special inks and mixtures thereof, and print any pixels and/or lines in an image. In the same image he can use multiple inks printed with commercially available printing machines and can set any level of complexity desired.

Advantages of the preferred embodiments include the following:

The encrypted mark is doubly protected both by the use of one or more special inks and by the use of special encrypted images that allow easy verification of the mark.

The mark can be printed using commercially available printing machines and can be incorporated into a print run that prints other non-coded information, for example to be used for labeling or similar function on the object

The production and design costs of the mark are low, and a mark is thus easily applied both to low and high volume production,

The same verification tools can be used for multiple marks,

Passive verification tools are inexpensive to manufacture and potentially use no active elements. That is to say they do not absolutely need light sources or detectors such as CCD's and other electronics,

It is possible to design a large range of custom verification tools to further enhance security. There is no need to design a specific verification tool for each customer. However, use of a specific verification tool in fact provides a method of sending enciphered images entirely separate from any verification function. That is to say a user could use the procedures of FIGS. 16 and 17 together with a customized optical processor, to send an image that is only readable to the person having the appropriate verification tool.

Optionally one can build a verification tool that verifies authenticity automatically relatively inexpensively simply by replacing the screen with a CCD detector and carrying out a standard image comparison.

Thus the embodiments of the present invention address the needs for anti-counterfeiting solutions as outlined in the background above. That is to say the solution is inexpensive to create in high volume, inexpensive to customize in low volume, inexpensive to verify in any volume, easy to verify, hard to falsify (counterfeit), and optionally can be verified automatically at low cost.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A printed mark comprising an array of printed positions each formed from one of a group of inks each having a predetermined spectrum, the positions being selected such as to form a predetermined image when said printed positions are viewed through a predetermined optical processor.

2. The mark of claim 1, wherein said image is a virtual image.

3. The mark of claim 1, wherein said image is a real image.

4. The mark of claim 1, wherein said predetermined image is a spectral domain image.

5. The mark of claim 4, wherein said predetermined printed positions form at least two object structures, and wherein said predetermined image comprises at least one image structure contributed to via said optical processor by said at least two object structures.

6. The mark of claim 1, wherein said image comprises a product identification code.

7. The mark of claim 1, further comprising a product identification code.

8. The mark of claim 1, comprising a digital printed pattern, wherein each printed position is a single print pixel.

9. The mark of claim 1, wherein said optical processor comprises a diffraction element.

10. The mark of claim 1, wherein said optical processor comprises a filter element.

11. The mark of claim 1, wherein said optical processor comprises a prism.

12. The mark of claim 1, wherein said optical processor is customized per mark.

13. The mark of claim 1, wherein said group of inks is taken from a larger pool of inks.

14. The mark of claim 13, wherein said pool comprises at least two inks having substantially a same color but a different spectral composition.

15. The mark of claim 13, wherein said group of inks comprises at least six inks.

16. The mark of claim 14, wherein said pool of inks comprises at least 25 inks.

17. The mark of claim 1, wherein said image comprises an identity photograph.

18. The mark of claim 1, wherein said image is an information carrying image.

19. A document carrying a mark, the mark comprising an array of printed positions each formed from one of a group of inks each having a predetermined spectrum, the positions being selected such as to form a predetermined image when said printed positions are viewed through an optical processor.

20. The document of claim 19, further carrying a printed version of said predetermined image for verification.

21. Packaging, carrying a mark, the mark comprising an array of printed positions each formed from one of a group of inks each having a predetermined spectrum, the positions being selected such as to form a predetermined image when said printed positions are viewed through an optical processor.

22. The packaging of claim 21, further carrying a printed version of said predetermined image for verification.

23. Electronically readable data storage medium, carrying a mark, the mark comprising an array of printed positions each formed from one of a group of inks each having a predetermined spectrum, the positions being selected such as to form a predetermined image when said printed positions are viewed through an optical processor.

24. The electronically readable data storage medium of claim 23 comprising any one of a group including: a magnetic disk, an encased magnetic disk, an optical disk, an audio tape, an encased audio tape, a video tape, and an encased video tape.

25. The electronically readable data storage medium of claim 23 wherein said mark is stored thereon in a form suitable for transfer by electronic mail.

26. The electronically readable storage medium of claim 23, wherein said mark is stored thereon in encrypted form.

27. The electronically readable storage medium of claim 26, wherein said mark is decryptable via a verification apparatus for reproducing said image.

28. A banknote carrying a mark, the mark comprising an array of printed positions each formed from one of a group of inks each having a predetermined spectrum, the positions being selected such as to form a predetermined image when said printed positions are viewed through an optical processor.

29. The banknote of claim 19, further carrying a printed version of said predetermined image for verification.

30. Apparatus for defining a source object comprising an array of printed positions using a group of inks each having a predetermined spectrum, the apparatus comprising:
an image definer for defining an image,
a reverse optical processor, associated with said image definer, for calculating a source image that leads via predetermined optical processing to said image,
and an output, associated with said reverse optical processor for providing at least a definition for printing said source object.

31. The apparatus of claim 30, wherein said optical processing comprises a polarization dependent effect.

32. The apparatus of claim 31, wherein said polarization dependent effect comprises retardation.

33. The apparatus of claim 31, wherein said polarization dependent effect comprises optical isolation.

34. The apparatus of claim 30, wherein said array of printed positions form at least two object structures, and wherein said source object is defined such that said image comprises at least one image structure contributed to, via said optical processing, by said at least two object structures.

35. The apparatus of claim 30, wherein each printed position is a high precision pixel.

36. The apparatus of claim 30, wherein said optical processing comprises diffracting.

37. The apparatus of claim 30, wherein said optical processing comprises filtering.

38. The apparatus of claim 30, wherein said optical processing is customized for given images.

39. The apparatus of claim 30, wherein said group of inks is taken from a larger pool of inks.

40. The apparatus of claim 39, wherein said pool comprises at least two inks having substantially a same color but a different spectral composition.

41. The apparatus of claim 30, wherein said group of inks comprises at least six inks.

42. The apparatus of claim 39, wherein said pool of inks comprises at least 25 inks.

43. Image forming apparatus for forming an image from a source object, the source object comprising an array of printed positions each formed from one of a group of inks each having a predetermined spectrum, the positions and the inks having been selected to form a predetermined image with an optical processor, the apparatus comprising such an optical processor, and a source item holder, said source item holder being located to define a predetermined distance between said optical processor and a source object in said source item holder, thereby to form an image to correspond to said predetermined image.

44. The apparatus of claim 43, wherein said image is a spectral domain image.

45. The apparatus of claim 44, wherein said array of printed positions form at least two object structures, and wherein said source object is defined such that said image comprises at least one image structure contributed to, via said optical processor, by said at least two object structures.

46. The apparatus of claim 43, wherein a packaging of an item carrying said object serves as said source item holder and is operative with said optical processor to define said distance.

47. The apparatus of claim 43, wherein said optical processor is embedded in a packaging of an item carrying said source object.

48. The apparatus of claim 46, wherein said optical processor is embedded in said packaging.

49. The apparatus of claim 43, further comprising an illumination source for illuminating said source object.

50. The apparatus of claim 49, operable to create the image at the retina of the eye of a verifier.

51. The apparatus of claim 49, further comprising a display screen for displaying a projection of said image.

52. The apparatus of claim 51, wherein said display screen comprises diffusion angle limitation.

53. The apparatus of claim 43, wherein said predetermined distance is variable per source object.

54. The apparatus of claim 43, wherein said optical processor comprises a diffraction element.

55. The apparatus of claim 43, wherein said optical processor comprises a filter element.

56. The apparatus of claim 43, wherein said optical processor comprises a prism.

57. The apparatus of claim 43, wherein said optical processor is exchangeable in accordance with definitions for each source object.

58. A method of defining a source object for a predetermined image comprising:
carrying out reverse optical processing of said predetermined image,
using said reverse optical processing to select pixel positions for printing said source object, and
using said reverse optical processing to select ones from a group of inks each having a predetermined spectrum, for said selected pixel positions, thereby to define said source object.

59. The method of claim 58, wherein said carrying out reverse optical processing comprises determining source object parts from image parts, placing into a look up table and then building said source image by compiling said parts from said look up table.

60. The method of claim 59, wherein for at least some image parts there are a plurality of possible source object parts.

61. The method of claim 60, wherein one of a group comprising random selection, systematic selection according to a formula and user selection, is used to select between said plurality of possible source object parts.

62. The method of claim 58, further comprising printing said source object.

63. The method of claim 62, wherein said printing is carried out on a document.

64. The method of claim 62, wherein said printing is carried out on packaging.

65. The method of claim 62, wherein said printing is carried out on currency notes.

66. The method of claim 58, wherein said reverse optical processing comprises processing from a spectral domain to a spatial domain.

67. The method of claim 66, wherein said selected pixel positions form at least two object structures, and wherein said source image is defined such that said image comprises at least one image structure contributed to, via optical processing, by said at least two object structures.

68. The method of claim 58, wherein said reverse optical processing comprises modeling in reverse an effect of a diffraction element.

69. The method of claim 68, wherein said diffraction element is a customized diffraction element.

70. The method of claim 58, wherein said reverse optical processing comprises modeling in reverse an effect of a filtering element.

71. A method of verifying authenticity of a mark-bearing item, the mark comprising an array of printed positions each formed from one of a group of inks each having a predetermined spectrum, the positions being selected such as to form a predetermined image when said printed positions are viewed through an optical processor, the method comprising:
applying said optical processor to form an image,
comparing said formed image with said predetermined image, and
if said formed image coincides with said predetermined image then authenticating said image bearing item.

72. The method of claim 71, wherein said predetermined image is a spectral domain image.

73. The method of claim 71, wherein said optical processor comprises a diffraction element.

74. The method of claim 71, wherein said optical processor comprises a prism.

75. The method of claim 71, wherein said optical processor comprises a filtering element.

76. The method of claim 71, wherein said predetermined image is carried on said image-bearing item.
